(19) United States
(12) Patent Application Publication
(10) Pub. No.: US 2025/0209036 A1
(43) Pub. Date: Jun. 26, 2025

(54) INTEGRATING AN AI ACCELERATOR WITH A CPU ON A SOC

(71) Applicants: XILINX, INC., San Jose, CA (US); Advanced Micro Devices, Inc., Santa Clara, CA (US)

(72) Inventors: Juan J. NOGUERA SERRA, San Jose, CA (US); Akila SUBRAMANIAM, Austin, TX (US); David KRAMER, Austin, TX (US); Madhusudan CHILAKAM, Boxborough, MA (US); Patrick KORAN, Boxborough, MA (US); Tim TUAN, San Jose, CA (US)

(21) Appl. No.: 18/394,859

(22) Filed: Dec. 22, 2023

(51) Int. Cl. G06F 15/78; G06F 12/1036

(52) U.S. Cl. CPC G06F 15/7825; G06F 12/1036

(57) ABSTRACT

Embodiments herein describe integrating an AI accelerator into a same SoC (or same chip or IC) as a CPU. Thus, instead of relying on off-chip communication techniques, on-chip communication techniques such as an interconnect (e.g., a NoC) can be used to facilitate communication. This can result in faster communication between the AI accelerator and the CPU. Moreover, a tighter integration between the CPU and AI accelerator can make it easier for the CPU to offload AI tasks to the Al accelerator. In one embodiment, the AI accelerator includes address translation circuitry for translating virtual addresses used in the AI accelerator to physical addresses used to store the data.

### TECHNICAL FIELD

Examples of the present disclosure generally relate to integrating an artificial intelligence (AI) accelerator in a same system on a chip (SoC) as a central processing unit (CPU).

### BACKGROUND

Typically, a hardware accelerator is an input/output (IO) device that is communicatively coupled to a CPU via a PCIe connection. The CPU and hardware accelerator can use direct memory access (DMA) and other communication techniques to share data.

Efforts have been made in recent years to bring the CPU logically closer to hardware accelerators by making the hardware accelerator cache coherent with the CPU. This provides additional options for transmitting data between the components. However, despite these efforts, the CPU and hardware accelerator are still separate components disposed on separate substrates (e.g., on different chips or different printed circuit boards (PCBs)) that use off-chip communication techniques such as PCIe to exchange data.

### SUMMARY

One embodiment described herein is a system on a chip (SoC) includes at least one central processing unit (CPU); an artificial intelligence (AI) accelerator that includes an array of data processing engines (DPEs), a network on chip (NoC), and an Input-Output Memory Management Unit (IOMMU) including circuitry configured to perform a virtual to physical address translation where the IOMMU is coupled to the array of DPEs via the NoC; and an interface communicatively coupling the CPU to the IOMMU in the AI accelerator.

One embodiment described herein is a method that includes receiving an instruction at an AI accelerator to perform an AI task from a CPU where the CPU and the AI accelerator are disposed on a same integrated circuit (IC), performing the AI task using DPEs in the AI accelerator, transmitting data generated by the DPEs when performing the AI task to a NoC in the AI accelerator, performing, at an IOMMU in the AI accelerator, an address translation on the data received from the NoC, and transmitting the address translated data to the CPU or a memory controller in the IC.

One embodiment described herein is a system that includes an IC that includes at least one CPU, an AI accelerator that includes DPEs, a NoC, and address translation circuitry configured to perform a virtual to physical address translation where the address translation circuitry is coupled to the DPEs via the NoC. The IC also includes a memory controller and an interface communicatively coupling the CPU to the address translation circuitry in the AI accelerator and to the memory controller. The system includes at least one external memory coupled to the memory controller in the IC.

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 illustrates a SoC with an AI accelerator, according to an example.

FIG. 2 illustrates an AI accelerator, according to an example.

FIG. 3 illustrates a workflow for communicating between an AI accelerator and a CPU, according to an example.

FIG. 4 is a block diagram of a data processing engine, according to an example.

FIG. 5 is a block diagram of an AI engine array, according to an example.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the embodiments herein or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

Embodiments herein describe integrating an AI accelerator into a same SoC (or same chip or integrated circuit (IC)) as a CPU. Thus, instead of relying on off-chip communication techniques, on-chip communication techniques such as an interconnect (e.g., a network-on-chip (NoC)) can be used to facilitate communication. This can result in faster communication between the AI accelerator and the CPU. Moreover, a tighter integration between the CPU and AI accelerator can make it easier for the CPU to offload AI tasks to the AI accelerator.

In one embodiment, the AI accelerator includes an array of data processing engines (DPEs) which include circuitry for performing AI tasks (e.g., inference or training tasks). In one example, the DPEs are arranged in rows and columns to form the array. Neighboring DPEs can communicate using direct neighbor connections while non-neighboring DPEs can communicate using a streaming network formed using interconnects in each of the DPEs.

The AI accelerator can also include an internal interface (e.g., a NoC) that couples to the array of DPEs in order to transmit data into, and receive processed data from, the DPEs. The internal interface can in turn be coupled to an Input-Output Memory Management Unit (IOMMU). Because the AI accelerator may process data using virtual addresses but the data may be stored in caches in the CPU or in external memory using physical addresses, the IOMMU performs a virtual to physical address translation before data processed by the AI accelerator is transmitted to other components in the SoC. These components can include the CPU as well as graphics processing units (GPU), video decoders (VDs), memory controllers (MCs), and the like. Put differently, the IOMMU performs address translation when transmitting data between the AI accelerator and the (larger) interface that couples the AI accelerator to other components in the SoC such as the CPU, GPU, MC, etc. In this manner, an AI accelerator can be integrated into the same SoC or IC as the CPU and other components.

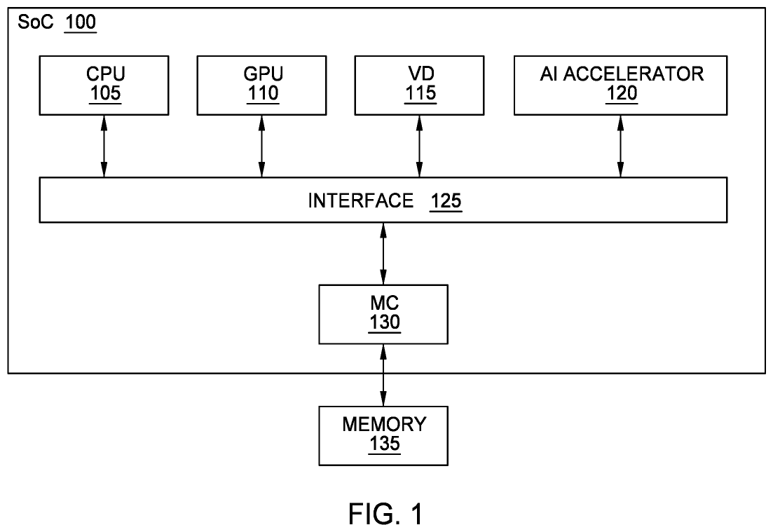

FIG. 1 illustrates a SoC 100 with an AI accelerator 120, according to an example. The SoC 100 can be a single IC or a single chip. In one embodiment, the SoC 100 includes a semiconductor substrate on which the illustrated components are formed using fabrication techniques.

The SoC 100 includes a CPU 105, GPU 110, VD 115, AI accelerator 120, interface 125, and MC 130. However, the SoC 100 is just one example of integrating an AI accelerator 120 into a shared platform with the CPU 105. In other examples, a SoC may include fewer components than what is shown in FIG. 1. For example, the SoC may not include the VD 115 or an internal GPU 110. However, in other examples, the SoC may include additional components than the ones shown in FIG. 1. Thus, FIG. 1 is just one example of components that can be integrated into a SoC with the Al accelerator 120.

The CPU 105 can represent any number of processors where each processor can include any number of cores. For example, the CPU 105 can include processors arranged in array, or the CPU 105 can include an array of cores. In one embodiment, the CPU 105 is an x86 processor that uses a corresponding complex instruction set. However, in other embodiments, the CPU 105 may be other types of CPUs such as an Advanced Reduced Set Instruction Computer (RSIC) Machine (ARM) processor.

The GPU 110 is an internal GPU 110 that performs accelerated computer graphics and image processing. The GPU 110 can include any number of different processing elements. In one embodiment, the GPU 110 can perform non-graphical tasks such as training an AI model or cryptocurrency mining.

The VD 115 can be used for decoding and encoding videos.

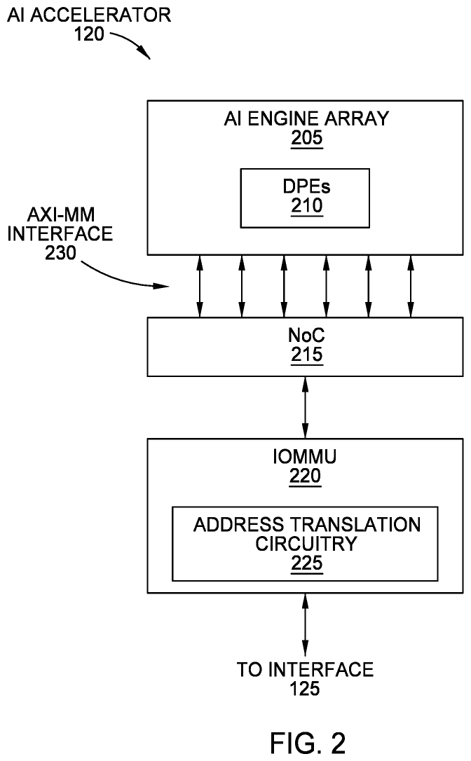

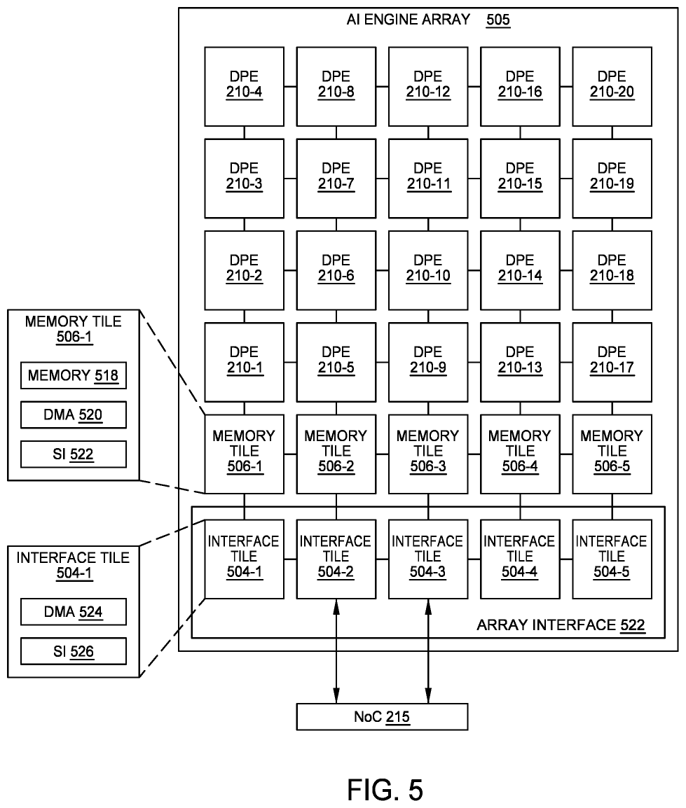

The AI accelerator 120 can include any hardware circuitry that is designed to perform AI tasks, such as inference. In one embodiment, the AI accelerator 120 includes an array of DPEs that performs calculations that are part of an AI task. These calculations can include math operations or logic operations (e.g., bit shifts and the like). The details of two implementations of the AI accelerator 120 are discussed in FIGS. 2 and 5.

The SoC 100 also includes one or more MCs 130 for controlling memory 135 (e.g., random access memory (RAM)). While the memory 135 is shown as being external to the SoC 100 (e.g., on a separate chip or chiplet), the MCs 130 could also control memory that is internal to the SoC 100.

The CPU 105, GPU 110, VD 115, AI accelerator 120, and MC 130 are communicatively coupled using an interface 125. Put differently, the interface permits the different types of circuitry in the SoC 100 to communicate with each other. For example, the CPU 105 can use the interface 125 to instruct the AI accelerator 120 to perform an AI task. The AI accelerator 120 can use the interface 125 to retrieve data (e.g., input for the AI task) from the memory 135 via the MC 130, process the data to generate a result, store the result in the memory 135 using the interface 125, and then inform the CPU 105 that the AI task is complete using the interface 125.

In one embodiment, the interface 125 is a NoC, but other types of interfaces such as internal buses are also possible.

FIG. 2 illustrates the AI accelerator 120, according to an example. The Al accelerator 120 can also be described as an inference processing unit (IPU) but is not limited to performing AI inference tasks.

The accelerator 120 includes an AI engine array 205 that includes a plurality of DPEs 210 (which can also be referred to as AI engines). The DPEs 210 may be arranged in a grid, cluster, or checkerboard pattern in the SoC 100 in FIG. 1—e.g., a 2D array with rows and columns. Further, the array 205 can be any size and have any number of rows and columns formed by the DPEs 210. One example layout of the array 205 is shown in FIG. 5.

In one embodiment, the DPEs 210 are identical. That is, each of the DPEs 210 (also referred to as tiles or blocks) may have the same hardware components or circuitry. In one embodiment, the array 205 includes DPEs 210 that are all the same type (e.g., a homogeneous array). However, in another embodiment, the array 205 may include different types of engines.

Regardless if the array 205 is homogenous or heterogeneous, the DPEs 210 can include direct connections between DPEs 210 which permit the DPEs 210 to transfer data directly to neighboring DPEs. Moreover, the array 205 can include a switched network that uses switches that facilitate communication between neighboring and non-neighboring DPEs 210 in the array 205.

In one embodiment, the DPEs 210 are formed from software-configurable hardened logic—i.e., are hardened. One advantage of doing so is that the DPEs 210 may take up less space in the SoC relative to using programmable logic to form the hardware elements in the DPEs 210. That is, using hardened logic circuitry to form the hardware elements in the DPE 210 such as program memories, an instruction fetch/decode unit, fixed-point vector units, floating-point vector units, arithmetic logic units (ALUs), multiply accumulators (MAC), and the like can significantly reduce the footprint of the array 205 in the SoC. Although the DPEs 210 may be hardened, this does not mean the DPEs 210 are not programmable. That is, the DPEs 210 can be configured when the SoC is powered on or rebooted to perform different AI functions or tasks.

While an AI accelerator 120 is shown, the embodiments herein can be extended to other types of integrated accelerators. For example, the accelerator could include an array of DPEs for performing other tasks besides AI tasks. For instance, the DPEs 210 could be digital signal processing engines, cryptographic engines, Forward Error Correction (FEC) engines, or other specialized hardware for performing one or more specialized tasks. In that case, the accelerator could be a cryptography accelerator, compression accelerator, and so forth.

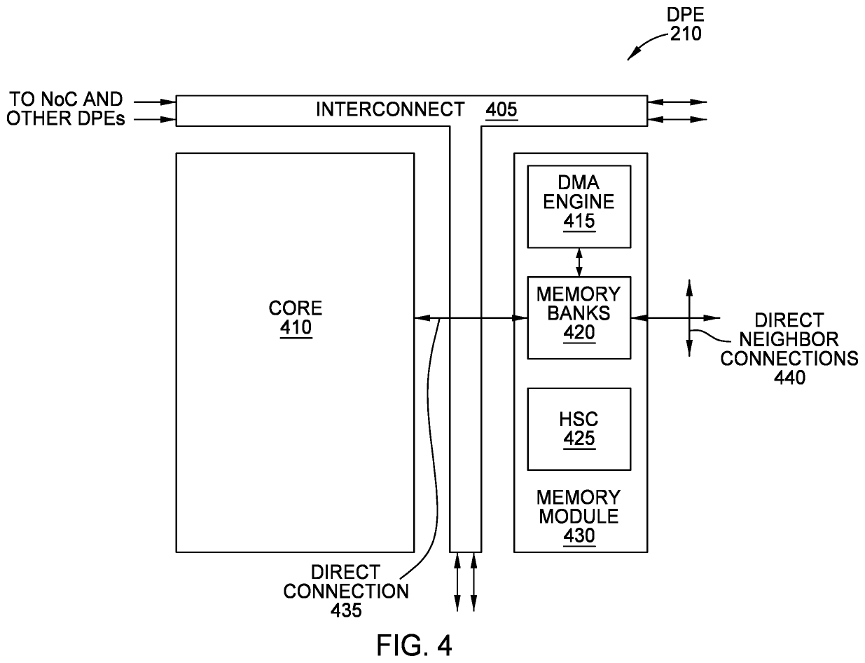

In this example, the DPEs 210 in the array 205 use the Advanced extensible Interface (AXI) memory-mapped (MM) interface 230 to communicate with a NoC 215. AXI is an on-chip communication bus protocol that is part of the Advanced Microcontroller Bus Architecture (AMBA) specification. An AXI MM interface 230 is used (rather than a AXI streaming interface) to transfer data between the DPEs 210 and the NoC 215 to access external memory, which requires using physical memory addresses. As discussed in FIG. 4 below, the DPEs can communicate with each other using a streaming protocol or interface (e.g., AXI streaming which does not use memory addresses) but a memory mapped protocol or interface (e.g., AXI MM) is used when transmitting data external to the array 205. In one embodiment, the array 205 can include interface tile (such as the interface tile 504 discussed in FIG. 5) that include primary and secondary DMA interfaces for transmitting data into and out of the array. When receiving data from the NoC 215, the interface tiles in the array 205 can transform the data into AXI streaming data.

In one embodiment, a memory mapped interface is also used to communicate between the NoC 215 and the IOMMU 220, and between the IOMMU 220 and the interface 125. However, these interfaces may be different types of memory mapped interfaces. For example, the interface between the NoC 215 and the IOMMU 220 may be AXI-MM, while the interface between the IOMMU 220 and the interface 125 is a different type of memory mapped interface. While AXI is discussed as one example herein, any suitable memory mapped and streaming interfaces may be used.

The NoC 215 may be a smaller interface than the interface 125 in FIG. 1. For example, the NoC 215 may be a miniature NoC when compared to using a NoC to implement the interface 125 in FIG. 1. The NoC 215 permits the DPEs 210 in the different columns of the AI engine array 205 to communicate with an IOMMU 220. The NoC 215 can include a plurality of interconnected switches. For example, the switches may be connected to their neighboring switches using north, east, south, and west connections.

In one embodiment, the data in the AI accelerator 120 is tracked using virtual memory addresses. However, other circuitry in the SoC 100 (e.g., caches in the CPUs 105, memory in the GPUs 110, the MC 130, etc.) may use physical memory addresses to store the data. The IOMMU 220 includes address translation circuitry 225 to perform memory address translation on data that flows into, and out of, the AI accelerator 120. For example, when receiving data from other circuitry in the SoC (e.g., from the MCs 130) via the interface 125, the address translation circuitry 225 may perform a physical-to-virtual address translation. When transmitting data from the AI accelerator 120 to be stored in the SoC or external memory 135 using the interface 125, the address translation circuitry 225 performs a virtual-to-physical address translation. For example, when using AXI-MM, the address translation circuitry 225 performs a translation between AXI-MM virtual addresses to physical addresses used to store the data in external memory or caches. While FIG. 2 illustrates using an IOMMU, the address translation function may be implemented using any suitable type of address translation circuitry.

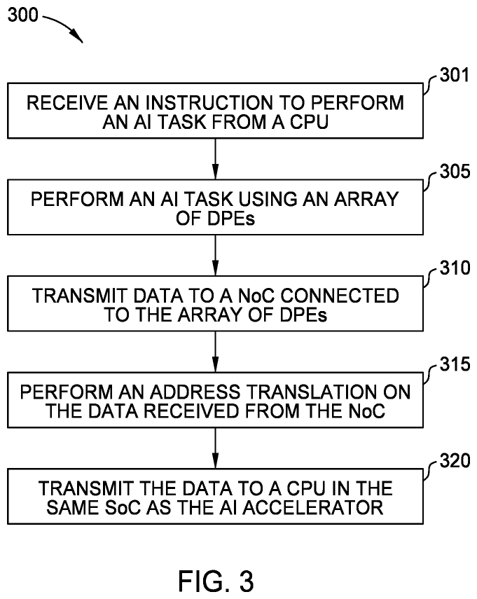

FIG. 3 illustrates a workflow of a method 300 for communicating between an AI accelerator and a CPU, according to an example. At block 301, the CPU (e.g., the CPU 105 in FIG. 1) transmits an instruction to the AI accelerator (e.g., the AI accelerator 120 in FIG. 1 or 2) to perform an AI task. For example, the AI task may be part of an application currently being executed by the CPU. Thus, the CPU can offload the AI task (or tasks) used by the application to the AI accelerator.

At block 305, the AI accelerator performs the AI task using an array of DPEs. The array of DPEs can be arranged as discussed above, or in any other suitable manner.

At block 310, the array of DPEs transmit data generated by performing the Al task to a NoC connected to the array. In one embodiment, the NoC in the AI accelerator is smaller than an interface (or NoC) that couples the AI accelerator to other components in the same SoC, such as the CPU, GPU, MC, etc.

In one embodiment, the data transmitted at block 310 is tracked using virtual memory addresses. For example, the data may have AXI MM virtual memory addresses. However, AXI MM is just one example of a suitable on-chip bus communication protocol that could be used. The embodiments herein can be used with any suitable communication protocol that uses virtual addressing.

At block 315, an IOMMU performs an address translation on the data received from the NoC. In one embodiment, the IOMMU converts the virtual memory addresses used by the AI accelerator to physical addresses used to store the data in memory, such as CPU caches or external memory. However, an IOMMU is just one example of circuitry that can perform this address translation.

At block 320, the interface in the SoC transmits the data to be stored. The interface may couple the AI accelerator to caches in the CPU as well to other components in the SoC such as a GPU, MC, and the like. Moreover, the interface may be much larger than the interface (e.g., NoC) in the AI accelerator. As such, in one embodiment, the interface 125 in FIG. 1 can be referred to as a global interconnect in the SoC while the NoC 215 in the AI accelerator in FIG. 2 can be referred to as a local interconnect (or mini interconnect/NoC) which is used only by components within the Al accelerator.

Once stored, the data may then be requested and processed by the CPU. For example, the CPU may performs its own physical-to-virtual translation on the data before it is processed. In some instances, the interface may transmit the data directly from the AI accelerator to the CPU for storage in, e.g., caches in the CPU. In other embodiments, the interface may first store the data in memory (e.g., external memory 135 in FIG. 1), then, when requested by the CPU, the interface transfers the data from memory to the CPU for processing.

FIG. 4 is a block diagram of a data processing engine, according to an example. FIG. 4 is a block diagram of a DPE 210 in the AI engine array 205 illustrated in FIG. 2, according to an example. The DPE 210 includes an interconnect 405, a core 410, and a memory module 430. The interconnect 405 permits data to be transferred from the core 410 and the memory module 430 to different cores in the array. That is, the interconnect 405 in each of the DPEs 210 may be connected to each other so that data can be transferred north and south (e.g., up and down) as well as east and west (e.g., right and left) between the DPEs 210 in the array.

For example, the DPEs 210 in an upper row of the array rely on the interconnects 405 in the DPEs 210 in a lower row to communicate with the NoC 215 shown in FIG. 2. For example, to transmit data to the NoC, a core 410 in a DPE 210 in the upper row transmits data to its interconnect 405 which is in turn communicatively coupled to the interconnect 405 in the DPE 210 in the lower row. The interconnect 405 in the lower row is connected to the NoC. The process may be reversed where data intended for a DPE 210 in the upper row is first transmitted from the NoC to the interconnect 405 in the lower row and then to the interconnect 405 in the upper row that is the target DPE 210. In this manner, DPEs 210 in the upper rows may rely on the interconnects 405 in the DPEs 210 in the lower rows to transmit data to and receive data from the NoC.

In one embodiment, the interconnect 405 includes a configurable switching network that permits the user to determine how data is routed through the interconnect 405. In one embodiment, unlike in a packet routing network, the interconnect 405 may form streaming point-to-point connections. That is, the streaming connections and streaming interconnects (not shown in FIG. 2) in the interconnect 405 may form routes from the core 410 and the memory module 430 to the neighboring DPEs 210 or the NoC. Once configured, the core 410 and the memory module 430 can transmit and receive streaming data along those routes. In one embodiment, the interconnect 405 is configured using the AXI Streaming protocol. However, when communicating with the NoC, the DPEs 210 may use the AXI MM protocol.

In addition to forming a streaming network, the interconnect 405 may include a separate network for programming or configuring the hardware elements in the DPE 210. Although not shown, the interconnect 405 may include a memory mapped interconnect (e.g., AXI MM) which includes different connections and switch elements used to set values of configuration registers in the DPE 210 that alter or set functions of the streaming network, the core 410, and the memory module 430.

In one embodiment, streaming interconnects (or network) in the interconnect 405 support two different modes of operation referred to herein as circuit switching and packet switching. In one embodiment, both of these modes are part of, or compatible with, the same streaming protocol—e.g., an AXI Streaming protocol. Circuit switching relies on reserved point-to-point communication paths between a source DPE 210 to one or more destination DPEs 210. In one embodiment, the point-to-point communication path used when performing circuit switching in the interconnect 405 is not shared with other streams (regardless whether those streams are circuit switched or packet switched). However, when transmitting streaming data between two or more DPEs 210 using packet-switching, the same physical wires can be shared with other logical streams.

The core 410 may include hardware elements for processing digital signals. For example, the core 410 may be used to process signals related to wireless communication, radar, vector operations, machine learning applications, and the like. As such, the core 410 may include program memories, an instruction fetch/decode unit, fixed-point vector units, floating-point vector units, arithmetic logic units (ALUs), multiply accumulators (MAC), and the like. However, as mentioned above, this disclosure is not limited to DPEs 210. The hardware elements in the core 410 may change depending on the engine type. That is, the cores in an AI engine, digital signal processing engine, cryptographic engine, or FEC may be different.

The memory module 430 includes a DMA engine 415, memory banks 420, and hardware synchronization circuitry (HSC) 425 or other type of hardware synchronization block. In one embodiment, the DMA engine 415 enables data to be received by, and transmitted to, the interconnect 405. That is, the DMA engine 415 may be used to perform DMA reads and write to the memory banks 420 using data received via the interconnect 405 from the NoC or other DPEs 210 in the array.

The memory banks 420 can include any number of physical memory elements (e.g., SRAM). For example, the memory module 430 may be include 4, 8, 16, 32, etc. different memory banks 420. In this embodiment, the core 410 has a direct connection 435 to the memory banks 420. Stated differently, the core 410 can write data to, or read data from, the memory banks 420 without using the interconnect 405. That is, the direct connection 435 may be separate from the interconnect 405. In one embodiment, one or more wires in the direct connection 435 communicatively couple the core 410 to a memory interface in the memory module 430 which is in turn coupled to the memory banks 420.

In one embodiment, the memory module 430 also has direct connections 440 to cores in neighboring DPEs 210. Put differently, a neighboring DPE in the array can read data from, or write data into, the memory banks 420 using the direct neighbor connections 440 without relying on their interconnects or the interconnect 405 shown in FIG. 4. The HSC 425 can be used to govern or protect access to the memory banks 420. In one embodiment, before the core 410 or a core in a neighboring DPE can read data from, or write data into, the memory banks 420, the core (or the DMA engine 415) requests a lock acquire to the HSC 425 when it wants to read or write to the memory banks 420 (i.e., when the core/DMA engine want to “own” a buffer, which is an assigned portion of the memory banks 420. If the core or DMA engine does not acquire the lock, the HSC 425 will stall (e.g., stop) the core or DMA engine from accessing the memory banks 420. When the core or DMA engine is done with the buffer, they release the lock to the HSC 425. In one embodiment, the HSC 425 synchronizes the DMA engine 415 and core 410 in the same DPE 210 (i.e., memory banks 420 in one DPE 210 are shared between the DMA engine 415 and the core 410). Once the write is complete, the core (or the DMA engine 415) can release the lock which permits cores in neighboring DPEs to read the data.

Because the core 410 and the cores in neighboring DPEs 210 can directly access the memory module 430, the memory banks 420 can be considered as shared memory between the DPEs 210. That is, the neighboring DPEs can directly access the memory banks 420 in a similar way as the core 410 that is in the same DPE 210 as the memory banks 420. Thus, if the core 410 wants to transmit data to a core in a neighboring DPE, the core 410 can write the data into the memory bank 420. The neighboring DPE can then retrieve the data from the memory bank 420 and begin processing the data. In this manner, the cores in neighboring DPEs 210 can transfer data using the HSC 425 while avoiding the extra latency introduced when using the interconnects 405. In contrast, if the core 410 wants to transfer data to a non-neighboring DPE in the array (i.e., a DPE without a direct connection 440 to the memory module 430), the core 410 uses the interconnects 405 to route the data to the memory module of the target DPE which may take longer to complete because of the added latency of using the interconnect 405 and because the data is copied into the memory module of the target DPE rather than being read from a shared memory module.

In addition to sharing the memory modules 430, the core 410 can have a direct connection to cores 410 in neighboring DPEs 210 using a core-to-core communication link (not shown). That is, instead of using either a shared memory module 430 or the interconnect 405, the core 410 can transmit data to another core in the array directly without storing the data in a memory module 430 or using the interconnect 405 (which can have buffers or other queues). For example, communicating using the core-to-core communication links may use less latency (or have high bandwidth) than transmitting data using the interconnect 405 or shared memory (which requires a core to write the data and then another core to read the data) which can offer more cost effective communication. In one embodiment, the core-to-core communication links can transmit data between two cores 410 in one clock cycle. In one embodiment, the data is transmitted between the cores on the link without being stored in any memory elements external to the cores 410. In one embodiment, the core 410 can transmit a data word or vector to a neighboring core using the links every clock cycle, but this is not a requirement.

In one embodiment, the communication links are streaming data links which permit the core 410 to stream data to a neighboring core. Further, the core 410 can include any number of communication links which can extend to different cores in the array. In this example, the DPE 210 has respective core-to-core communication links to cores located in DPEs in the array that are to the right and left (east and west) and up and down (north or south) of the core 410. However, in other embodiments, the core 410 in the DPE 210 illustrated in FIG. 4 may also have core-to-core communication links to cores disposed at a diagonal from the core 410. Further, if the core 410 is disposed at a bottom periphery or edge of the array, the core may have core-to-core communication links to only the cores to the left, right, and bottom of the core 410.

However, using shared memory in the memory module 430 or the core-to-core communication links may be available if the destination of the data generated by the core 410 is a neighboring core or DPE. For example, if the data is destined for a non-neighboring DPE (i.e., any DPE that DPE 210 does not have a direct neighboring connection 440 or a core-to-core communication link), the core 410 uses the interconnects 405 in the DPEs to route the data to the appropriate destination. As mentioned above, the interconnects 405 in the DPEs 210 may be configured when the SoC is being booted up to establish point-to-point streaming connections to non-neighboring DPEs to which the core 410 will transmit data during operation.

FIG. 5 is a block diagram of an AI engine array 205, according to an example. In this example, AI engine array 205 includes a plurality of circuit blocks, or tiles, illustrated here as the DPEs 210 (also referred to as DPE tiles or compute tiles), interface tiles 504, and memory tiles 506. Memory tiles 506 may be referred to as shared memory and/or shared memory tiles. Interface tiles 504 may be referred to as shim tiles, and may be collectively referred to as an array interface 528. Like in FIG. 2, the AI engine array 205 is coupled to the NoC 215. FIG. 5 further illustrates that the interface tiles 504 communicatively couple the other tiles in the AI engine array 205 (i.e., the DPEs 210 and memory tiles 506) to the NoC 215.

DPEs 210 can include one or more processing cores, program memory (PM), data memory (DM), DMA circuitry, and stream interconnect (SI) circuitry, which are also described in FIG. 4. For example, the core(s) is the DPEs 210 can execute program code stored in the PM. The core(s) may include, without limitation, a scalar processor and/or a vector processor. DM may be referred to herein as local memory or local data memory, in contrast to the memory tiles which have memory that is external to the DPE tiles, but still within the AI engine array 205.

The core(s) may directly access data memory of other DPE tiles via DMA circuitry. The core(s) may also access DM of adjacent (or neighboring) DPEs 210 via DMA circuitry and/or DMA circuitry of the adjacent compute tiles. In one embodiment, DM in one DPE 210 and DM of adjacent DPE tiles may be presented to the core(s) as a unified region of memory. In one embodiment, the core(s) in one DPE 210 may access data memory of non-adjacent DPEs 210. Permitting cores to access data memory of other DPE tiles may be useful to share data amongst the DPEs 210.

The AI engine array 205 may include direct core-to-core cascade connections (not shown) amongst DPEs 210. Direct core-to-core cascade connections may include unidirectional and/or bidirectional direct connections. Core-to-core cascade connections may be useful to share data amongst cores of the DPEs 210 with relatively low latency (e.g., the data does not traverse stream interconnect circuitry such as the interconnect 405 in FIG. 4, and the data does not need to be written to data memory of an originating DPE and read by a recipient or destination DPE). For example, a direct core-to-core cascade connection may be useful to provide results from an accumulation register of a processing core of an originating DPE directly to a processing core(s) of a destination DPE.

In an embodiment, DPEs 210 do not include cache memory. Omitting cache memory may be useful to provide predictable/deterministic performance. Omitting cache memory may also be useful to reduce processing overhead associated with maintaining coherency among cache memories across the DPEs 210.

In an embodiment, processing cores of the DPE 210 do not utilize input interrupts. Omitting interrupts may be useful to permit the processing cores to operate uninterrupted. Omitting interrupts may also be useful to provide predictable and/or deterministic performance.

One or more DPEs 210 may include special purpose or specialized circuitry, or may be configured as special purpose or specialized compute tiles such as, without limitation, digital signal processing engines, cryptographic engines, forward error correction (FEC) engines, and/or artificial intelligence (AI) engines.

In an embodiment, the DPEs 210, or a subset thereof, are substantially identically to one another (i.e., homogenous compute tiles). Alternatively, one or more DPEs 210 may differ from one other more other DPEs 210 (i.e., heterogeneous compute tiles).

Memory tile 506-1 includes memory 518 (e.g., random access memory or RAM), DMA circuitry 520, and stream interconnect (SI) circuitry 522.

Memory tile 506-1 may lack or omit computational components such as an instruction processor. In an embodiment, memory tiles 506, or a subset thereof, are substantially identical to one another (i.e., homogenous memory tiles). Alternatively, one or more memory tiles 506 may differ from one other more other memory tiles 506 (i.e., heterogeneous memory tiles). A memory tile 506 may be accessible to multiple DPEs 210. Memory tiles 506 may thus be referred to as shared memory.

Data may be moved between/amongst memory tiles 506 via DMA circuitry 520 and/or stream interconnect circuitry 522 of the respective memory tiles 506. Data may also be moved between/amongst data memory of a DPE 210 and memory 518 of a memory tile 506 via DMA circuitry and/or stream interconnect circuitry of the respective tiles. For example, DMA circuitry in a DPE 210 may read data from its data memory and forward the data to memory tile 506-1 in a write command, via stream interconnect circuitry in the DPE 210 and stream interconnect circuitry 522 in the memory tile 506. DMA circuitry 524 of memory tile 506-1 may then write the data to memory 518. As another example, DMA circuitry 520 of memory tile 506-1 may read data from memory 518 and forward the data to a DPE 210 in a write command, via stream interconnect circuitry 522 and stream interconnect circuitry in the DPE 210, and DMA circuitry in the DPE 210 can write the data to its data memory.

Array interface 528 interfaces between the AI engine array 205 (e.g., DPEs 210 and memory tiles 506) and the NoC 215. Interface tile 504-1 includes DMA circuitry 524 and stream interconnect circuitry 526. Interface tiles 504 may be interconnected so that data may be propagated amongst interface tiles 504 bi-directionally. An interface tile 504 may operate as an interface for column of DPEs 210 (e.g., as an interface to the NoC 215). Interface tiles 504 may be connected such that data may be propagated from one interface tile 504 to another interface tile 504 bi-directionally.

In an embodiment, interface tiles 504, or a subset thereof, are substantially identically to one another (i.e., homogenous interface tiles). Alternatively, one or more interface tiles 504 may differ from one other more other interface tiles 504 (i.e., heterogeneous interface tiles).

In an embodiment, one or more interface tiles 504 is configured as a NoC interface tile (e.g., as master and/or slave device) that interfaces between the DPEs 210 and the NoC 215 (e.g., to access other components in the SoC). While FIG. 5 illustrates coupling a subset of the interface tiles 504 to the NoC 215, in one embodiment, each of the interface tiles 504-1-5 is connected to the NoC 215. Doing so may permit different applications to control and use different columns of the memory tiles 506 and DPEs 210.

DMA circuitry and stream interconnect circuitry of the AI engine array 205 may be configurable/programmable to provide desired functionality and/or connections to move data between/amongst DPEs 210, memory tiles 506, and the NoC 215. The DMA circuitry and stream interconnect circuitry of the AI engine array 205 may include, without limitation, switches and/or multiplexers that are configurable to establish signal paths within, amongst, and/or between tiles of the AI engine array 205. The AI engine array 205 may further include configurable AXI interface circuitry. The DMA circuitry, the stream interconnect circuitry, and/or AXI interface circuitry may be configured or programmed by storing configuration parameters in configuration registers, configuration memory (e.g., configuration random access memory or CRAM), and/or eFuses, and coupling read outputs of the configuration registers, CRAM, and/or eFuses to functional circuitry (e.g., to a control input of a multiplexer or switch), to maintain the functional circuitry in a desired configuration or state. In an embodiment, the core(s) of DPEs 210 configure the DMA circuitry and stream interconnect circuitry of the respective DPEs 210 based on core code stored in PM of the respective DPEs 210. A controller (not shown) can configure DMA circuitry and stream interconnect circuitry of memory tiles 506 and interface tiles 504 based on controller code.

The AI engine array 205 may include a hierarchical memory structure. For example, data memory of the DPEs 210 may represent a first level (L1) of memory, memory 518 of memory tiles 506 may represent a second level (L2) of memory, and external memory outside the AI engine array 205 may represent a third level (L3) of memory. Memory capacity may progressively decrease with each level (e.g., memory 518 of memory tile 506 may have more storage capacity than data memory in the DPEs 210, and external memory may have more storage capacity than data memory 518 of the memory tiles 506). The hierarchical memory structure is not, however, limited to the foregoing examples.

As an example, an input tensor may be relatively large (e.g., 1 megabyte or MB). Local data memory in the DPEs 210 may be significantly smaller (e.g., 64 kilobytes or KB). The controller may segment an input tensor and store the segments in respective blocks of shared memory tiles 506.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. A system on a chip (SoC), comprising:
at least one central processing unit (CPU);
an artificial intelligence (AI) accelerator, comprising:
an array of data processing engines (DPEs),
a network on chip (NoC), and
an Input-Output Memory Management Unit (IOMMU) comprising circuitry configured to perform a virtual to physical address translation, wherein the IOMMU is coupled to the array of DPEs via the NoC; and
an interface communicatively coupling the CPU to the IOMMU in the Al accelerator.

2. The SoC of claim 1, wherein the IOMMU is configured to translate virtual addresses used by the AI accelerator to physical addresses used to store data in memory before transmitting the data from the AI accelerator to the interface.

3. The SoC of claim 2, wherein the virtual addresses are memory mapped virtual addresses, wherein the memory mapped virtual addresses are used to transmit the data from the array of DPEs, through the NoC, and to the IOMMU.

4. The SoC of claim 3, wherein the memory mapped virtual addresses are Advanced extensible Interface (AXI) memory-mapped (MM) virtual addresses.

5. The SoC of claim 1, wherein the interface is a second NoC, wherein the second NoC is larger than the NoC in the AI accelerator.

6. The SoC of claim 1, further comprising:
a graphics processing unit (GPU), wherein the interface communicatively couples the GPU to the CPU.

7. The SoC of claim 1, further comprising:
at least one memory controller, wherein the interface communicatively couples the memory controller to the CPU and to the AI accelerator.

8. The SoC of claim 1, wherein each of the DPEs comprises a core, a memory module, and an interconnect, wherein the interconnects in the DPEs are interconnected so that the DPEs are able to transmit data between each other.

9. The SoC of claim 1, wherein the CPU is configured to transmit instructions, via the interface, to the AI accelerator to perform AI tasks.

10. A method, comprising:
receiving an instruction at an AI accelerator to perform an AI task from a CPU, wherein the CPU and the AI accelerator are disposed on a same integrated circuit (IC);
performing the AI task using DPEs in the AI accelerator;
transmitting data generated by the DPEs when performing the AI task to a NoC in the AI accelerator;
performing, at an IOMMU in the AI accelerator, an address translation on the data received from the NoC; and
transmitting the address translated data to the CPU or a memory controller in the IC.

11. The method of claim 10, performing the address translation comprises:
translating virtual addresses used by the AI accelerator to physical addresses used to store the address translated data in at least one of caches in the CPU or in an external memory.

12. The method of claim 11, wherein the virtual addresses are memory mapped virtual addresses, wherein the memory mapped virtual addresses are used to transmit the data from the DPEs, through the NoC, and to the IOMMU.

13. The method of claim 12, wherein the memory mapped virtual addresses are AXI MM virtual addresses.

14. The method of claim 10, wherein transmitting the address translated data to the CPU or the memory controller is performed using an interface in the IC, wherein the interface is a second NoC that is larger than the NoC in the AI accelerator.

15. The method of claim 14, wherein the IC comprises a GPU, wherein the interface communicatively couples the GPU to the CPU.

16. The method of claim 14, wherein the interface communicatively couples the memory controller to the CPU and to the AI accelerator.

17. The method of claim 10, wherein each of the DPEs comprises a core, a memory module, and an interconnect, wherein the interconnects in the DPEs are interconnected so that the DPEs transmit data between each other when performing the AI task.

18. A system, comprising:
an IC, comprising:
at least one CPU,
an AI accelerator, comprising:
DPEs,
a NoC, and
address translation circuitry configured to perform a virtual to physical address translation, wherein the address translation circuitry is coupled to the DPEs via the NoC,
a memory controller, and
an interface communicatively coupling the CPU to the address translation circuitry in the AI accelerator and to the memory controller; and
at least one external memory coupled to the memory controller in the IC.

19. The system of claim 18, wherein the address translation circuitry is configured to translate virtual address used by the AI accelerator to physical addresses used to store data in the external memory before transmitting the data from the AI accelerator to the interface.

20. The system of claim 19, wherein the virtual addresses are memory mapped virtual addresses, wherein the memory mapped virtual addresses are used to transmit the data from the DPEs, through the NoC, and to the address translation circuitry.
